(19) United States
(12) Patent Application Publication
(10) Pub. No.: US 2012/0112680 A1
(43) Pub. Date: May 10, 2012

(54) ELECTRIC MACHINE SYSTEM INCLUDING AN ALTERNATING ELECTRIC CURRENT (AC) ELECTRIC MACHINE HAVING A SWITCH MODULE

(75) Inventors: Bradley D. Chamberlin, Pendleton, IN (US); Alex Creviston, Muncie, IN (US)

(73) Assignee: REMY TECHNOLOGIES, L.L.C., Pendleton, IN (US)

(21) Appl. No.: 12/939,325

(22) Filed: Nov. 4, 2010

(51) Int. Cl. H02P 27/04; H02K 9/19

(52) U.S. Cl. 318/503; 310/54

(57) ABSTRACT

An electric machine system includes an alternating current (AC) electric machine. The AC electric machine includes a machine housing having a machine portion and a switch portion. A stator is fixedly mounted in the machine portion of the machine housing and a rotor is rotatably mounted relative to the stator. A switch assembly is arranged within the switch portion of the machine housing and electrically connected to the stator. The switch assembly includes at least one switch module having at least one switch member. The at least one switch module is configured and disposed to be detachably mounted in the switch portion of the machine housing. A direct current (DC) power source is electrically connected to the stator through the switch assembly. A controller is operatively connected to the switch assembly.

### BACKGROUND OF THE INVENTION

Exemplary embodiments pertain to the art of electric machines and, more particularly, to an alternating current (AC) electric machine having a switch module.

Conventional electric motor systems, such as those used in automotive, agricultural, and other heavy duty applications where electric and hybrid motors are employed, include an electric motor operatively coupled to an inverter through high voltage cabling. A typical inverter includes a controller portion and a multi-phase power switching portion. The multi-phase power switching portion includes various high voltage components such as insulated gate bipolar transistors (IGBTs), metal oxide semiconductor field effect transistors (mosfets), rectifiers, capacitors, inductors, high voltage wiring and the like. The inverter is electrically connected to an engine control module, a high voltage battery, and the electric motor. The connections between the inverter and the battery, and the inverter and the electric motor, require high voltage cabling. In addition, the heat generated by operation of the high voltage components requires cooling. As such, conventional inverters are also typically connected to a dedicated cooling system. Cooling systems for inverters include a fluid coolant such as oil, water, air or other media that can absorb and retain heat.

### BRIEF DESCRIPTION OF THE INVENTION

Disclosed is an electric machine system including an alternating current (AC) electric machine. The AC electric machine includes a machine housing having a machine portion and a switch portion. A stator is fixedly mounted in the machine portion of the machine housing and a rotor is rotatably mounted relative to the stator. A switch assembly is arranged within the switch portion of the machine housing and electrically connected to the stator. The switch assembly includes at least one switch module having at least one switch member. The at least one switch module is configured and disposed to be detachably mounted in the switch portion of the machine housing. A direct current (DC) power source is electrically connected to the stator through the switch assembly. A controller is operatively connected to the switch assembly. The controller is configured and disposed to operate the switch assembly to convert direct current from the DC power source to an alternating current to operate the AC electric machine.

Also disclosed is an alternating current (AC) electric machine including a machine housing having a machine portion and a switch portion. A stator is fixedly mounted in the machine portion of the machine housing and a rotor is rotatably mounted relative to the stator. A switch assembly is arranged within the switch portion of the machine housing and electrically connected to the stator. The switch assembly includes at least one switch module having at least one switch member. The at least one switch module is configured and disposed to be detachably mounted in the switch portion of the machine housing.

### BRIEF DESCRIPTION OF THE DRAWINGS

The following descriptions should not be considered limiting in any way. With reference to the accompanying drawings, like elements are numbered alike:

FIG. 1 depicts an electric machine system including an alternating current (AC) electric machine having a switch assembly in accordance with an exemplary embodiment;

FIG. 2 depicts the AC electric machine of FIG. 1 having a switch assembly including a plurality of switch modules in accordance with one aspect of the exemplary embodiment; and

FIG. 3 depicts and AC electric machine of FIG. 1 having a switch assembly including a switch module in accordance with another aspect of the exemplary embodiment.

### DETAILED DESCRIPTION OF THE INVENTION

A detailed description of one or more embodiments of the disclosed apparatus and method are presented herein by way of exemplification and not limitation with reference to the Figures.

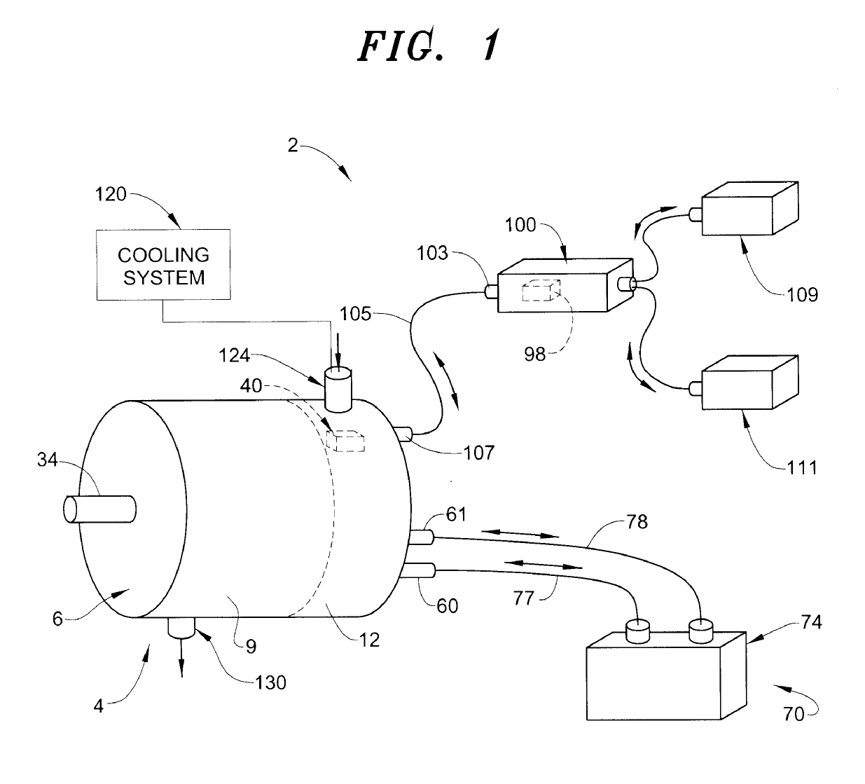

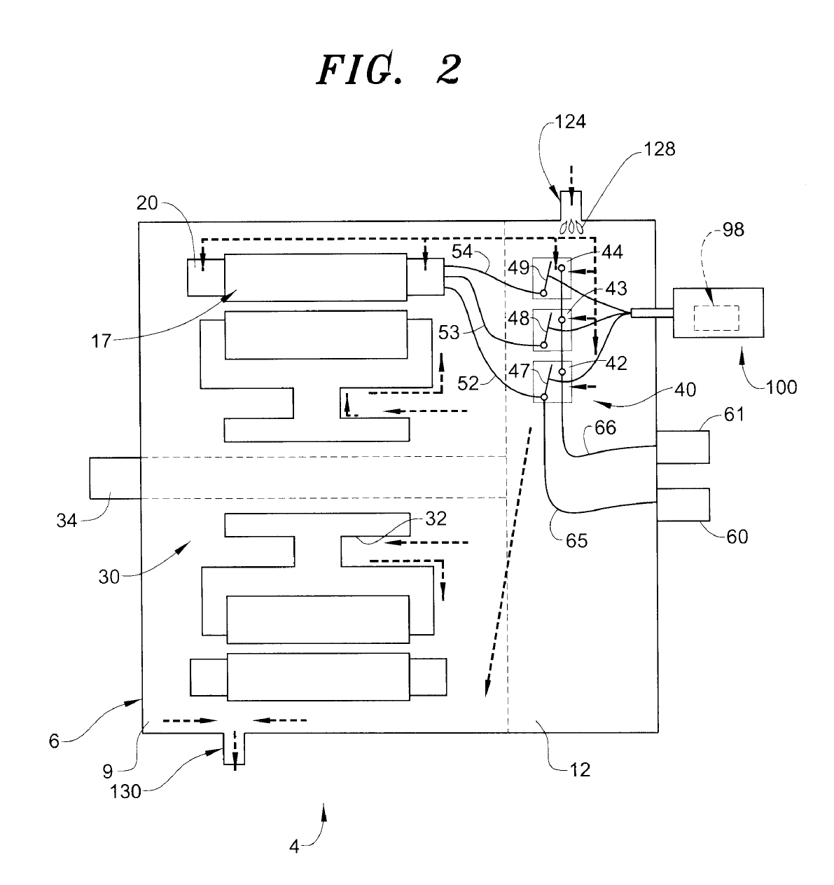

With reference to FIGS. 1 and 2, an electric machine system constructed in accordance with an exemplary embodiment is indicated generally at 2. Electric machine system 2 includes an alternating current (AC) electric machine shown in the form of an electric motor 4 having a machine housing 6. Machine housing 6 includes a machine portion 9 and a switch portion 12. In the exemplary embodiment shown, machine portion 9 includes a stator assembly 17 having a plurality of windings 20. Windings 20 define a number of phases for AC electric motor 4. More specifically, AC electric motor 4 constitutes a multi-phase AC electric motor. Machine portion 9 is also shown to include a rotor assembly 30 having a rotor hub 32 that is operatively coupled to an output shaft 34. At this point, it should be understood that the electric machine in accordance with the exemplary embodiment could take the form of an electric motor, i.e., an electric machine provided with an electric current input to produce a mechanical output or an electric generator, i.e., an electric machine provided with a mechanical input that is transformed into an electrical current.

In accordance with an exemplary embodiment, switch portion 12 of machine housing 6 includes a switch assembly 40. As will be discussed more fully below, switch assembly 40 is operated to convert direct current (DC) from a DC power source to an alternating current (AC) to power AC electric motor 4. In accordance with an exemplary embodiment, switch assembly 40 includes a plurality of switch modules 42, 43, and 44. Each switch module 42-44 is detachably mounted within switch portion 12 of machine housing 6. More specifically, in the event of a switch failure, each switch module 42-44 may be selectively individually replaced. In this manner, failure of a single switch will not require a complete replacement of switch assembly 40. In the exemplary embodiment shown, each switch module 42-44 includes a corresponding switch member 47, 48, and 49.

Switch members 47-49 are selectively activated (opened/closed) to establish multiple phases for AC electric motor 4. More specifically, switch member 47 of switch module 42 establishes a first phase for AC electric motor 4. Switch member 48 of switch module 43 establishes a second phase for AC electric motor 4, and switch member 49 of switch module 44 establishes a third phase for AC electric motor 4. Thus, switch module 42 is electrically connected to a first phase (not separately labeled) of windings 20 through a first high voltage conductor 52, switch module 43 is electrically connected to a second phase (not separately labeled) of windings 20 through a second high voltage conductor 53, and switch module 44 is electrically connected to a third phase (not separately labeled) of windings 20 through a third high voltage conductor 54. Switch modules 42-44 are also connected to a pair of power terminals 60 and 61 through respective ones of high voltage power conductors 65 and 66. “High voltage” should be understood to mean any voltage shared between electric AC motor 4 and a power supply. In accordance with one exemplary aspect, “high voltage” is voltage in a range of between about 100 volts and about 1000 volts or more. Voltage should be understood to include voltage supplied by switch assembly 40 to the electric machine when operated in a motor mode or passed to switch assembly 40 when the electric machine is operated in a generator mode. In general, voltage should be understood to include energy that is exchanged between the electric machine and switch assembly 40 resulting in a transformation of energy between a mechanical and electrical state. Power terminals 60 and 61 are also electrically connected to a direct current (DC) power source 70, shown in the form of a high voltage battery 74, by high voltage cables 77 and 78 respectively. Thus, in the exemplary embodiment shown, AC electric motor 4 is provided power by DC power source 62.

Electric machine system 2 is shown to include a controller 98 that is electrically connected to switch assembly 40. Controller 98 electrically activates (opens/closes) switch modules 42-44 to transform DC electrical current from DC power source 70 to a multi-phase AC electric current that is used to power AC electric motor 4. Controller 98 is arranged within a controller housing 100 that is remote from AC electric motor 4. Controller housing 100 includes a control terminal 103 that electrically connects controller 98 to AC electric motor 4. More specifically, controller 98 is linked to switch assembly 40 by a low voltage cable 105 that extends between control terminal 103 and a control terminal element 107 provided on machine housing 6. “Low voltage” should be understood to mean voltage shared between controller 98 and switch assembly 40 employed to achieve a change in state, e.g., open/close, switch members 47-49. In accordance with one aspect of the exemplary embodiment, “low voltage” constitutes voltage in a range between greater than about 0 volts and about 99 volts. Electric machine system 2 is also includes a motor control module 109 electrically connected to controller 98. Motor control module 109 establishes a desired operational speed/condition for AC electric motor 4. Controller 98 is also shown linked to additional control inputs 111 could also include accessory control modules, or other vehicle operational parameters such as torque, speed, power and the like.

Electric machine system 2 is further shown to include a cooling system 120. Cooling system 120 includes a coolant input port 124 and a coolant output port 130 that are fluidly connected to machine housing 6. Coolant input port 124 directs a coolant 140, such as air, oil, water, a glycol mixture, or the like towards switch portion 12 of AC electric motor 4. Coolant 128 is passed in thermally conductive proximity to switch assembly 40 to absorb heat from each switch module 42-44. Coolant 128 then flows toward machine portion 9 of machine housing 6. The coolant flows in thermally conductive proximity to stator assembly 17, rotor hub 32 and rotor laminations (not separately labeled). Coolant 128 absorbs additional heat from stator assembly 17 and rotor assembly 30 before passing from machine housing 6 through coolant output port 130. Coolant 128 then passes through a heat exchanger to remove any entrained heat and is reintroduced to AC electric machine 4. Alternatively, coolant 128 may be passed to other devices.

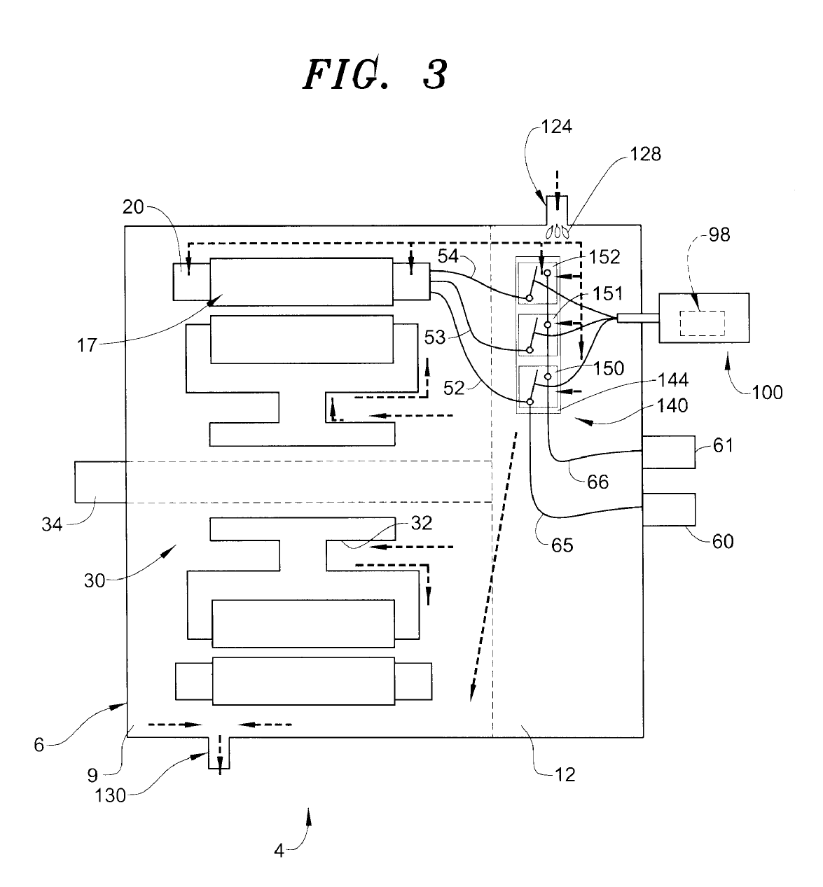

Reference will now be made to FIG. 3, wherein like reference numbers represent corresponding parts in the respective views, in describing a switch assembly 140 in accordance with another aspect of an exemplary embodiment. Switch assembly 140 includes a switch module 144. Switch module 144 is selectively detachably mounted within AC electric motor 4. In accordance with one aspect of the exemplary embodiment, switch module 144 includes a plurality of switch members 150-151 that electrically connect DC power source 74 with stator assembly 17. Switch module 144 establishes a desired electrical connection configuration for stator assembly 17. More specifically, switch module 144 establishes a series electrical configuration for stator assembly 17. Of course it should be understood, that AC electric machine 4 could be provided with a switch module that establishes a parallel electrical configuration, a wye electrical configuration, or a delta electrical configuration for AC electric motor 4.

At this point it should be understood, that the exemplary embodiments eliminate the need for replacing an entire switch assembly in the event of a failure of a single switch member. Providing individual switch modules enables a technician to replace only those switch members that are deemed faulty. Exemplary embodiments also provide a simple, cost effect system for changing an electrical configuration of an electric motor. The electric motor is provided with a switch module that is pre-wired or pre-configured with a particular electrical configuration. In this manner, changing the electrical configuration of an electric motor is as simple as replacing the switch module.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. An electric machine system comprising:
an alternating current (AC) electric machine including a machine housing having a machine portion and a switch portion, a stator fixedly mounted in the machine portion of the machine housing, a rotor rotatably mounted relative to the stator, and a switch assembly arranged within the switch portion of the machine housing and electrically connected to the stator, the switch assembly including at least one switch module having at least one switch member, the at least one switch module being configured and disposed to be detachably mounted in the switch portion of the machine housing;
a direct current (DC) power source electrically connected to the stator through the switch assembly; and
a controller operatively connected to the switch assembly, the controller being configured and disposed to operate the switch assembly to convert direct current from the DC power source to an alternating current to operate the AC electric machine.

2. The electric machine system according to claim 1, wherein the at least one switch module comprises a plurality of switch modules electrically connecting the DC power source and the stator.

3. The electric machine system according to claim 2, wherein the plurality of switch modules includes a first switch module that establishes a first electrical phase, a second switch module that establishes a second electrical phase, and a third switch module that establishes a third electrical phase, the AC electric machine being operated on the first, second, and third electrical phases.

4. The electric machine system according to claim 1, wherein the switch module includes a plurality of switch members that electrically connect the DC power source with the stator.

5. The electric machine system according to claim 4, wherein the plurality of switch members includes a first switch member that establishes a first electrical phase, a second switch member that establishes a second electrical phase, and a third switch member that establishes a third electrical phase, the AC electric machine being operated on the first, second, and third electrical phases.

6. The electric machine system according to claim 4, wherein the switch module establishes a particular electrical connection between the DC power source and the stator.

7. The electric machine system of claim 6, wherein the particular electrical connection comprises one of a series connection and a parallel connection.

8. The electric machine system of claim 1, further comprising: a cooling system fluidly connected to the machine housing, the cooling system directing a coolant in thermally conductive proximity to the at least one switch module and at least one of the stator and the rotor.

9. An alternating current (AC) electric machine comprising:
a machine housing having a machine portion and a switch portion;
a stator fixedly mounted in the machine portion of the machine housing;
a rotor rotatably mounted relative to the stator; and
a switch assembly arranged within the switch portion of the machine housing and electrically connected to the stator, the switch assembly including at least one switch module having at least one switch member, the at least one switch module being configured and disposed to be detachably mounted in the switch portion of the machine housing.

10. The AC electric machine according to claim 9, wherein the at least one switch module comprises a plurality of switch modules configured and disposed to electrically connect a DC power source and the stator.

11. The AC electric machine according to claim 10, wherein the plurality of switch modules includes a first switch module that establishes a first electrical phase, a second switch module that establishes a second electrical phase, and a third switch module that establishes a third electrical phase, the AC electric machine being operated on the first, second, and third electrical phases.

12. The AC electric machine according to claim 9, wherein the switch module includes a plurality of switch members that are configured and disposed to electrically connect a DC power source with the stator.

13. The AC electric machine according to claim 12, wherein the plurality of switch members includes a first switch member that establishes a first electrical phase, a second switch member that establishes a second electrical phase, and a third switch member that establishes a third electrical phase, the AC electric machine being operated on the first, second, and third electrical phases.

14. The AC electric machine according to claim 13, wherein the switch module is configured and disposed to establishes a particular electrical connection a DC power source and the stator.

15. The AC electric machine according to claim 14, wherein the particular electrical connection comprises one of a series connection and a parallel connection.

16. The AC electric machine according to claim 9, further comprising: a cooling system fluidly connected to the machine housing, the cooling system directing a coolant in thermally conductive proximity to the at least one switch module and at least one of the stator and the rotor.
